(19) United States
(12) Patent Application Publication
(10) Pub. No.: US 2004/0192531 A1
(43) Pub. Date: Sep. 30, 2004

(54) Dunnage conversion system with multi-ply web detection

(76) Inventor: Hans Meessen, Wiljre (NL)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/780,113

(22) Filed: Feb. 17, 2004

Related U.S. Application Data
(60) Provisional application No. 60/447,866, filed on Feb. 14, 2003.

(51) Int. Cl. B31B 1/14

(52) U.S. Cl. 493/350

(57) ABSTRACT

A dunnage conversion system and method for converting multiple plies of sheet material into a relatively less dense, three-dimensional dunnage product, includes providing a sensor for each ply to detect an end thereof and ceasing operation of the system upon detection of the end of any one of the plies. Detecting the end of the shortest of the plies will cease operation of the system to permit splicing a new supply to the end of the spent supply.

This application claims the benefit of U.S. Provisional Patent Application No. 60/447,866, filed on Feb. 14, 2003.

### FIELD OF THE INVENTION

The present invention relates to dunnage converters that convert multi-ply sheet stock material into a dunnage product. More particularly, the invention relates to a dunnage conversion system with end-of-web detection.

### BACKGROUND

Various dunnage converters (also commonly called cushioning conversion machines) heretofore have been used to convert sheet stock material into a dunnage product for use in packaging items in containers for shipment. The sheet stock material is usually supplied in the form of a roll from which the sheet stock material is payed off for conversion by the converter into the dunnage product. When the roll is spent, a new roll is loaded in place of the spent roll and the leading end of the new roll is inserted into the machine. One way of accomplishing this is to splice the leading end of the new roll to the trailing end of an almost spent roll. When the machine is once again operated, the trailing end of the almost spent roll will pull the leading end of the new roll through the machine.

Some cushioning conversion machines are equipped with a splicing plate adjacent the path of the stock material and over which the stock material passes at the upstream end of the machine. The splicing plate provides a surface on which the ends of multiple layers of stock material may be cut to provide straight edges for splicing. The leading and trailing ends of plies of the new and spent rolls can be spliced together using several different techniques known in the art.

Previously an end-of-web detector has been used to detect when a stock roll or other supply of stock material is nearing its depleted or exhausted state. U.S. Pat. No. 5,749,821 discloses a typical end-of-web detector. The detector uses a photoelectric sensor including a transmitter and a receiver for transmitting and receiving a signal, such as a light beam. The sensor and a corresponding reflector are positioned at a location between a stock supply roll and the inlet end of a converter housing such that the stock material is fed between the sensor and the reflector. When the end of the stock web has not yet passed the sensor, the light beam generated by the sensor is transmitted toward the reflector but is interrupted by the web crossing the path of the beam before it can reach the reflector and return to the sensor. This lack of a reflected signal indicates to the sensor the presence of the stock material. When the stock supply has become exhausted and the end of the stock material has passed the sensor, the light beam generated by the sensor will be reflected back along the beam path by the reflector and the sensor will thus detect the absence of the stock material. A signal indicating detection of the end of the stock material is supplied to the controller for the converter which stops the conversion process until a new stock roll is loaded in place.

For a long time now, operators of the converters that use multi-ply paper have encountered a problem in that ends of the plies of a spent roll do not always align with one another. The end of one or more of the plies may be short of the end of another ply. This could arise from the original winding process where the multiple plies do not begin at the same point on the core of the stock roll. However, usually the problem arises from a slight differential consumption rate of the multiple plies which causes a loop to form in one or more of the plies. When the trailing ends of the plies leave the core at the end of spent roll, the loop in the ply causes that ply to be longer than the other ply or plies. With the prior art end-of-web detector, the sensor triggers an end-of-web command only after the longest ply has passed the beam path.

Quite frequently, the end of one or more of the plies may be so short that it has passed the end of the splicing plate by the time the converter is stopped, thereby making it very difficult, if not impossible, to splice to it a ply from a new stock roll. If the splice cannot be made, the operator has to remove the remainder of the stock material from the spent roll and thread the leading end of the stock material from the new roll through the machine, which is a much more difficult and time-consuming process than simply splicing the leading end of a new roll to the trailing end of a spent roll.

### SUMMARY

The present invention provides a dunnage conversion system and method for converting multiple plies of sheet material into a relatively less dense, three-dimensional dunnage product, wherein a sensor is provided for each ply to detect the end thereof and operation of the system is ceased upon detection of the end of any one of the plies. This solves the aforesaid problem since detection of the end of the shortest of the plies will cease operation of the system to permit splicing of a new supply to the end of the spent supply.

More particularly, the system comprises a converter including a conversion assembly that is driven by a motor to advance multiple plies of sheet material through the converter for conversion of the multiple plies of sheet material into a relatively less dense, three-dimensional dunnage product, the multiple plies of sheet stock material being fed to the conversion assembly along respective infeed paths; a controller that controls operation of the motor; and an end-of-web detector located upstream of the conversion assembly, the end-of-web detector including plural sensors respectively associated with the separate infeed paths for detecting the presence or absence of the respective ply and providing an output to the controller indicative thereof.

In a preferred embodiment, the plural sensors each include a transmitter for transmitting an electromagnetic beam and a receiver for receiving the electromagnetic beam. The transmitter and receiver of each sensor can be located on the same side of the infeed path for the respective ply of sheet stock material, and the end-of-web detector can further include a reflective surface for each sensor disposed on an opposite side of the infeed path and positioned to reflect the electromagnetic beam transmitted by the transmitter to the receiver of the respective sensor. The reflective surfaces for a pair of the sensors can be located on opposite sides of a reflector body located between the infeed paths of respective plies of the sheet stock material. There can also be provided a splicing surface against which the trailing ends of the plies of a spent supply of stock material can be joined to the leading ends of the plies of a new supply of stock material, and the sensors can be located at an upstream end of the splicing surface.

According to another aspect of the invention, a method of converting multiple plies of sheet material into a relatively less dense, three-dimensional dunnage product, comprises the steps of: operating a motor of a converter to drive a conversion assembly that advances multiple plies of sheet material through the converter for conversion of the multiple plies of sheet material into a relatively less dense dunnage product; feeding multiple plies of sheet stock material to the conversion assembly along respective infeed paths; using plural sensors respectively associated with the separate infeed paths to detect the presence or absence of the respective ply; and ceasing operation of the motor in response to a signal from any one of the plural sensors.

The foregoing and other features of the invention are hereinafter fully described and particularly pointed out in the claims, the following description and the annexed drawings setting forth in detail an illustrative embodiment of the invention, such being indicative, however, of but one of the various ways in which the principles of the invention may be employed.

### BRIEF DESCRIPTION OF THE DRAWINGS

FIG. 1 is a diagrammatic illustration of a dunnage conversion system according to the invention.

FIG. 2 is a perspective view of an exemplary physical manifestation of the dunnage conversion system.

FIG. 3 is an enlarged perspective view showing a splicing plate and end-of-web detector assembly according to a preferred embodiment of the invention.

FIG. 4 is a cross-sectional view of the splicing plate and end-of-web detector assembly looking from the line 4-4 of FIG. 3.

### DETAILED DESCRIPTION

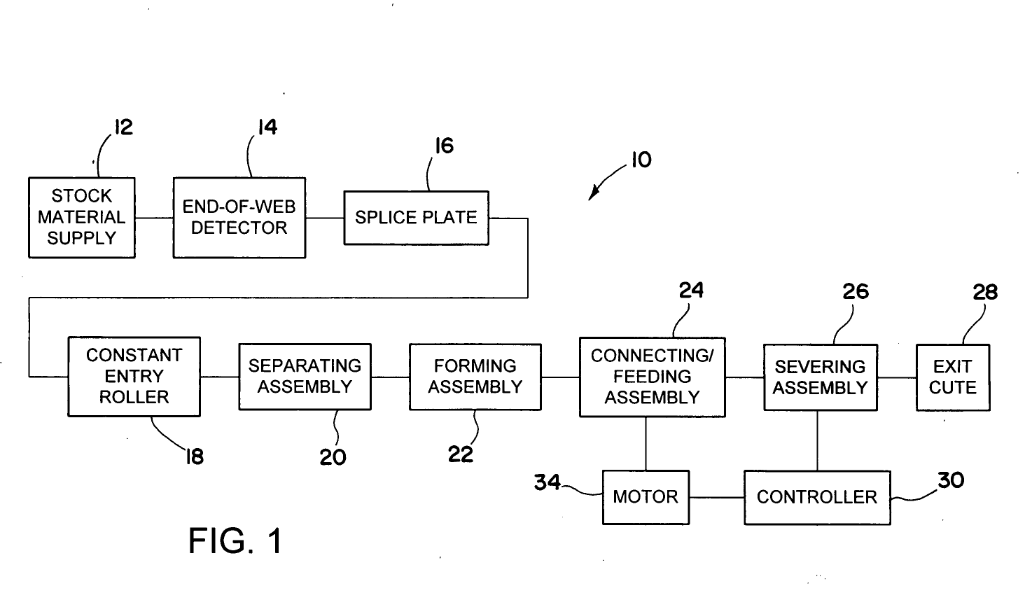

Referring now to the drawings in detail and initially to FIG. 1, a dunnage conversion system 10 according to a preferred embodiment of the invention is diagrammatically illustrated. The system 10 generally comprises a stock material supply 12, an end-of-web detector 14, a splice plate 16, a constant entry guide 18, a separating assembly 20, a forming assembly 22, a feeding assembly 24, a severing assembly 26, an exit chute 28 and a controller 30.

The stock material supply 12 can include a suitable holder for a supply of multi-ply sheet material that is to be converted into a dunnage product. The stock material, which can be in the form of a roll of wound stock material, comprises two or more plies of sheet material. Each ply can be made of paper, for example, thirty or fifty pound weight kraft paper. Also, one or more of the plies can be made of another type of sheet material and/or paper, such as printed paper, bleached paper, etc., or combinations thereof.

The multi-ply sheet stock material is fed past the end-of-web detector 14 and the splicing plate 16 to the constant entry guide 18. From the constant entry guide 18, the plies of the sheet stock material are separated as they pass through the separating assembly 20 to the forming assembly 22 and feeding assembly 24. The forming and feeding assemblies 22 and 24 function as conversion assemblies to convert the sheet stock material into a relatively less dense, three-dimensional dunnage product as the sheet stock material is advanced through the system by the feeding assembly. Operation of the conversion assemblies and specifically the feeding assembly 24 is controlled by the controller 30. More particularly, the feeding assembly 24 is driven by a motor 34 that is controlled by the controller 30. When power is supplied to the motor 34, it drives the feeding assembly 24, which acts on the sheet stock material to pull it from the supply 12 for passage through the forming and feeding assemblies 22 and 24, thereby converting the sheet stock material into a dunnage product. The dunnage product exits the system 10 through the exit chute 28 after passing by a severing assembly 26. The severing assembly 26 is controlled by the controller 30 to sever the dunnage product into discrete sections, or pads, that can be used to pack items in containers.

The stock material supply 12, splice plate 16, constant entry roller 18, separating assembly 20, forming assembly 22, feeding assembly 24, severing assembly 26, exit chute 28 and controller 30 can take many forms. Examples of such components are described in U.S. Pat. Nos. 4,699,609, 5,123,889, 5,755,656, 6,174,273, 6,200,251, 6,203,481, 6,210,310, 6,277,459, 6,387,029, 6,468,197, and 6,491,614 and other patents assigned to Ranpak Corp. of Concord, Ohio, U.S.A As is apparent from these exemplary disclosures, not all of the above-mentioned components need be employed. For instance, some dunnage converters do not employ a separating assembly. Also, one or more of the components may perform multiple functions. For example, the feeding assembly may also perform a crumpling and/or connecting function that maintains or assists in maintaining the converted shape and character of the three-dimensional dunnage product.

In one type of dunnage converter, a typical forming assembly 22 and feeding assembly 24 causes crumpling of the stock material alone or in conjunction with an inward turning or folding of lateral edge portions of the sheet stock material, and this may form one or more pillow portions. The forming assembly 22 can include a former located within a converging chute, and the feeding assembly 24 can include opposed translating or rotating members, e.g., gear-like members, that define therebetween a pinch zone through which a portion of the stock material is squeezed. One or both of the translating or rotating members is driven whereby such members function to move the stock material through the system. Additional feeding devices could also be provided. In addition, the controller 30 can be of a well-known type and preferably uses a microprocessor or other suitable logic device. In addition, the functions of the controller can be carried out by one or more processors located in a single unit or separate units.

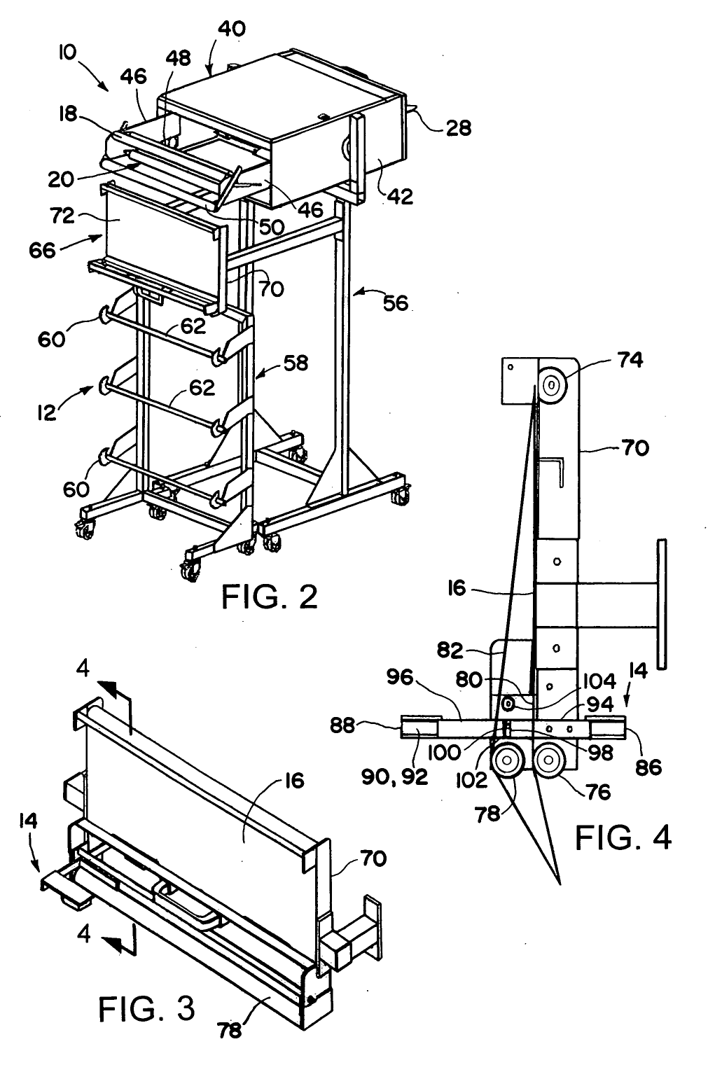

Referring now to FIG. 2, a physical manifestation of the dunnage conversion system 10 is shown. The system 10 generally comprises a converter 40 including a housing 42 in which the forming, feeding and severing assemblies 22, 24 and 26 (FIG. 1) are mounted and thus hidden from view in FIG. 2. At the right in FIG. 2, the end of the exit chute 28 can be seen.

The converter housing 42 has a pair of rearwardly projecting, laterally spaced apart arms 46 for supporting the constant entry guide 18 and separating assembly 20. The constant entry guide 18 preferably is a roller mounted between the two arms 46 for rotation. The separating assembly 20 preferably includes one or more separator bars or rollers 48 mounted between the arms 46 at a location between the constant entry roller 18 and the forming assembly 22 in the converter housing 42. The illustrated system 10 also is equipped with a dancer arm and roller assembly 50 for controlling tension on the paper in a well-known manner.

In the illustrated system 10, the converter 40 is mounted on a stand 56 in a horizontal orientation, although it should be understood that the converter 40 can be otherwise oriented. The stock material supply 12 also includes a stand 58 to which one or more supports 60 are mounted for supporting one or more multi-ply stock rolls on spindles 62. As will be appreciated, the below-described end-of-web detector also lends itself to use with multiple single ply stock rolls, each stock roll supplying a respective one of the multiple plies of sheet stock material.

As further shown in FIG. 2, the converter stand 56 can have mounted thereto an assembly 66 including the splicing plate 16 and the end-of-web detector 14. As illustrated, the assembly 66 is located between the stock material supply 12 and the constant entry guide 18.

In FIGS. 3 and 4, the splicing plate and end-of-web detector assembly 66 is shown in greater detail. The assembly 66 includes a frame 70 to which the splicing plate 16 is mounted. A guide roller 74 is mounted at the top of the frame 70, while guide and separator rollers 76 and 78 are mounted at the bottom of the frame 70. The latter rollers 76 and 78 guide the respective plies of the multi-ply stock material along respective infeed paths 80 and 82.

The end-of-web detector 14 includes plural sensors 86 and 88 respectively associated with the separate infeed paths 80 and 82 for detecting the presence or absence of the respective ply of sheet stock material and providing an output to the controller 30 indicative thereof. In the illustrated embodiment, there are two such sensors 86 and 88 for detecting two plies. However, the detector 14 can include one or more additional sensors for detecting one or more additional plies. The sensors 86, 88 provide signals to the controller 30 indicating the presence and/or absence of a ply at the respective infeed path.

In the illustrated embodiment, each sensor 86, 88 includes a transmitter 90 for transmitting an electromagnetic beam and a receiver 92 for receiving the electromagnetic beam. Preferably, both the transmitter 90 and the receiver 92 are located in a single sensing unit and such units can be of known type that are readily available in the marketplace. In the illustrated embodiment, the sensors 86 and 88 are mounted to respective arms 94 and 96 extending from the frame 70, the arms extending generally perpendicular to the infeed paths 80 and 82.

The transmitter and receiver of each sensor 86, 88 are located on the same side of the infeed path 80, 82 for the respective ply of sheet stock material. On the other side of the infeed path 80, 82 there is located a reflective surface 98, 100. The reflective surface is positioned to reflect the electromagnetic beam transmitted by the transmitter to the receiver of the respective sensor. In the illustrated embodiment, the reflective surfaces for the illustrated pair of the sensors are located on opposite sides of a reflector body 102 located between the infeed paths 80 and 82 of respective plies of the sheet stock material. Also located between the infeed paths 80, 82 and downstream of the reflector body 102 is a guide roller 104. Those skilled in the art will appreciate that the sensors 86, 88 and reflectors 98, 100 can be otherwise arranged, and that other type of sensors can be employed. For instance, the receivers may be positioned opposite the transmitters in place of the reflectors, or vice versa. Also, the reflectors may be replaced by other devices such as a prism, which can function to redirect incident light to the location of the receiver. Also, transmitters of other types may be used, such as an ultrasonic transmitter.

As is preferred, the end-of-web detector 14 is located at the upstream end of the splicing plate 16 (it should be noted that the terms “upstream” and “downstream” are herein used in relation to the direction of flow of the stock material through the system 10). The splicing plate 16 has a flat, planar splicing surface against which the trailing ends of the plies of a spent supply of stock material can be joined to the leading ends of the plies of a new supply of stock material.

In operation, the motor 34 (FIG. 1) can be controllably operated by the controller 30 (FIG. 1) to produce a dunnage product. When the motor 34 is powered, sheet stock material is fed from the supply 12 and through the converter 40 wherein the stock material is converted into the dunnage product. The motor 34 can be operated as needed to produce a dunnage product as long as there is stock material in the converter.

As the stock supply 12 (e.g., a stock roll) is depleted, the trailing end of one of the plies will move beyond the respective sensor 86, 88, at which point the sensor will report to the controller 30 that an end of ply has been detected. In response, the controller 30 will discontinue any further production of dunnage until a new supply is spliced to the trailing end of the stock material of the spent roll. This will occur regardless of which ply end is detected. Consequently, the splicing plate 16 will be overlapped by all of the plies since the shortest of the plies will function to cease operation of the converter 40. At this point, the trailing ends of the longer plies preferably are trimmed to the same length, and the leading ends of the plies of a new supply are spliced to respective plies of the old supply, after having been threaded along the respective infeed paths 80, 82 of the end-of-web detector 14. The controller 30 can then once again be operated to produce the dunnage product from the new supply of sheet stock material.

Although the invention has been shown and described with respect to a certain embodiment, equivalent alterations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer that performs the specified function of the described integer (i.e., that is functionally equivalent), even though not structurally equivalent to the disclosed structure that performs the function in the herein illustrated exemplary embodiment of the invention.

What is claimed is:

1. A dunnage conversion system for converting multiple plies of sheet material into a relatively less dense, three-dimensional dunnage product, the system comprising: a converter including a conversion assembly that is driven by a motor to advance multiple plies of sheet material through the converter for conversion of the multiple plies of sheet material into a relatively less dense, three-dimensional dunnage product, where the multiple plies of sheet stock material are fed to the conversion assembly along respective infeed paths; a controller that controls operation of the motor; and an end-of-web detector located upstream of the conversion assembly, the end-of-web detector including plural sensors respectively associated with the separate infeed paths for detecting the presence or absence of the respective ply and providing an output to the controller indicative thereof.

2. A conversion system as set forth in claim 1, wherein the plural sensors each include a transmitter for transmitting an electromagnetic beam and a receiver for receiving the electromagnetic beam.

3. A conversion system as set forth in claim 2, wherein the transmitter and receiver of each sensor are located on the same side of the infeed path for the respective ply of sheet stock material, and the end-of-web detector further includes a reflective surface for each sensor disposed on an opposite side of the infeed path and positioned to reflect the electromagnetic beam transmitted by the transmitter to the receiver of the respective sensor.

4. A conversion system as set forth in claim 3, wherein the reflective surfaces for a pair of the sensors are located on opposite sides of a reflector body located between the infeed paths of respective plies of the sheet stock material.

5. A conversion system as set forth in claim 4, comprising a splicing surface against which the trailing ends of the plies of a spent supply of stock material can be joined to the leading ends of the plies of a new supply of stock material, and the sensors are located at an upstream end of the splicing surface.

6. A conversion system as set forth in claim 5, further comprising at least one spacer member interposed between the infeed paths of the sheet stock material plies for separating the plies, and wherein the reflector body is located between the splicing surface and the spacer member.

7. A conversion system as set forth in claim 1, further comprising at least one spacer member interposed between the infeed paths of the sheet stock material plies for separating the plies.

8. A method of converting multiple plies of sheet material into a relatively less dense, three-dimensional dunnage product, comprising the steps of:
operating a motor of a converter to drive a conversion assembly that advances multiple plies of sheet material through the converter for conversion of the multiple plies of sheet material into a relatively less dense dunnage product;
feeding multiple plies of sheet stock material to the conversion assembly along respective infeed paths;
using plural sensors respectively associated with the separate infeed paths to detect the presence or absence of the respective ply; and
ceasing operation of the motor in response to a signal from any one of the plural sensors.
